(19) United States
(12) Patent Application Publication
(10) Pub. No.: US 2007/0229025 A1
(43) Pub. Date: Oct. 4, 2007

(54) CONNECTOR CHARGER

(75) Inventors: Cheng-Che Tsai, Taipei County (TW); Sheng-Tsun Chiu, Taipei County (TW); Ming-Hsin Chen, Taipie county (TW)

Correspondence Address: WPAT, PC, 7225 BEVERLY ST., ANNANDALE, VA, 22003, US

(73) Assignee: KYE SYSTEMS CORP., Taipei County (TW)

(21) Appl. No.: 11/689,305

(22) Filed: Mar. 21, 2007

(30) Foreign Application Priority Data
Apr. 4, 2006 (TW) 095111907

(51) Int. Cl. H02J 7/02

(52) U.S. Cl. 320/111

(57) ABSTRACT

A connector charger is disclosed, which is adapted to electrically connect to an external electronic device by a connection port arranged at an end of its casing while the connection port is electrically connected to a charging circuit device and at least a contact disposed inside the casing. By arranging at least a socket on the casing at a position corresponding to each contact for enabling rechargeable batteries to plug in the casing therefrom and connect electrically to the corresponding contact, the power of the external device can be transmitted to the connector charger by the electric circuit formed of the connection port, each contact and the electronic device, wherein the charging circuit device is enabled to convert the power of the external electronic device into electric current suitable for the rechargeable batteries and then the converted electric current is fed to the rechargeable batteries through the contact for charging the same.

### FIELD OF THE INVENTION

The present invention relates to a connector charger, and more particularly, to a charging device capable of using a specific interface and charging circuit device thereof to convert power, being fed therein from a connection port thereof, into electric current suitable for charging various types of rechargeable batteries, that is adapted for computer peripheral devices and portable electronic devices.

### BACKGROUND OF THE INVENTION

For meeting the requirements of digital files with rapidly increasing size, connection ports of high transmission rate, such as universal serial bus (USB) ports, are replacing the RS232, that is common used as the transmission interface in early computer peripheral devices, and are becoming the standard transmission interface for modern computer peripheral devices or portable electronic devices. In addition, as specified in the standard of modern connection port, it is able to provide a voltage of DC5V so that many studies and researches had been proposed for using the same as power source of various devices.

One such study is the USB device with charging ability, disclosed in TW Pat. NO. 91216780. It is substantially a USB flash disk embedded with a charging structure, by which the USB flash disk is equipped with abilities other than data accessing/storage. In one embodiment, such USB flash disk is structure with a rechargeable battery and a illumination device, by which the rechargeable battery can be charged while the USB flash disk is plugged into a computer for data accessing/storage, and thus USB flash disk can be used as an lighting device after separating from the computer since the illustration device is able to emit light using the power of the rechargeable battery. However, as the aforesaid charging structure is integrated with the USB flash disk, it can be used only for charging those devices integrated with the USB flash disk, and can not be used for charging devices, apparatuses, or batteries external to the USB flash disk.

One other such study is a cellular phone charger with USB interface, disclosed in TW Pat. No. 88219291. It is substantially a power cord with USB plug that is only adapted for charging a cellular phone and can not be used for charging other devices, apparatuses, or batteries.

One other such study is a wireless transmission module with charging function, disclosed in TW Pat. No. 92217081. In the wireless transmission module, a connection terminal is arranged between a wireless transmitter and a wireless receiver, by which the wireless transmitter can be electrically connected to the wireless receiver so as to charge a rechargeable battery embedded inside the wireless transmitter, and for that reason the wireless transmission module is free from the trouble of dead battery or power shortage. However, the aforesaid structure is only adapted for the wireless transmission module and can not be used for charging other devices, apparatuses, or batteries

One other such study is a charger, disclosed in TW Pat. No. 094203583, in which a first and a second bases, capable of interconnecting with each other, are provided. Two corresponding-positioned accommodation slots are respectively designed in the first and the second bases and used respectively for receiving a rechargeable battery, while each accommodation slot is fitted with a conducting plate. Furthermore, a power connector is arranged in the first base that is able to connect to an external power source while electrically connecting to its conducting plate. Therefore, by the electric circuit formed of the two rechargeable batteries and the conducting plates, the external power source can be used for charging the two rechargeable batteries. However, the shortcoming of the aforesaid charge is that it can be used for charging batteries of a specified size. That is, since the first base is designed to fixedly connect to the power connector, only the batteries of specified type and size capable of fitting with the first base and the second base can be charged by such charger. Thus, it is not convenient to use and is economically unsound.

### SUMMARY OF THE INVENTION

In view of the disadvantages of prior art, the primary object of the present invention is to provide a connector charger, capable of using a specific interface and charging circuit device thereof to convert power, being fed therein from a connection port thereof, into electric current suitable for charging various rechargeable batteries, that is adapted for computer peripheral devices and portable electronic devices.

To achieve the above object of the invention, the present invention provides a connector charger for charging rechargeable batteries, which is comprised of:
a casing, having an accommodation space formed therein;
a connection port, arranged at an end of its casing in an manner that it is channeling with the accommodation space and being adapted to electrically connect to an external electronic device;
a charging circuit device, arranged inside the accommodation space of the casing while electrically connecting to the connection port;
at least a contact, each disposed inside the casing while electrically connecting to the charging circuit device; and
at least a socket, each formed on the casing at a position corresponding to the at least one contact in a manner that each is channeling with the accommodation space;
wherein, as a rechargeable battery is connected electrically to the at least one contact, an electric circuit can be formed by the electrical-connection of the connection port, the at least one contact and the external electronic device so as to feed the power of the external electronic device to the rechargeable battery for charging the same.

Preferably, the connector charger further comprises a positioning device used for fixedly secured the rechargeable battery while enabling the same to have exact contact with the at least one contact.

Preferably, the positioning device is composed of reeds relatively disposed at two opposite sides of the rechargeable battery.

Preferably, each reed is designed with an extruding portion positioned at a position corresponding to an indentation formed on the rechargeable battery, and thus the reeds can securely hold on to the rechargeable battery by fitting the extruding portion into the indentation.

Preferably, the casing is composed of a top shell and a bottom shell.

Preferably, the connection port can be structured to be disposed a distance away from the charging circuit device and is electrically connected to the charging circuit device by a connecting wire of a specific length.

Preferably, the connecting wire can be received inside the casing in a roll-up manner.

Preferably, the connection port further comprises an On-The-Go (OTG) port.

Preferably, the charging circuit device further comprises a circuit board structured with charging related circuits of current detection, voltage detection, and the likes.

Preferably, the charging circuit device further comprises a temperature detection circuit.

Preferably, the charging circuit device is a switchable circuit, capable of switching between different voltages for enabling the same to charge batteries of different voltages.

Preferably, the charging circuit device further comprises a charging indication circuit, used for indicating statuses of electric quantity, charging state, power supply, and the likes.

Preferably, the charging indication circuit is an audio/visual unit of specific audio and optical effects.

Preferably, the contact can be an object selected from the group consisting of a reed, a spring and the combination thereof.

Preferably, the connector charger further comprises a battery holder, which includes: a holder head, used for connecting to the at least one contact; a case, connected to the holder head and having an inner space formed therein for receiving at least a rechargeable battery; a conductive device, disposed between the hold head and the inner space of the case so as to enable the at least one contact to be electrically connected to the at least one rechargeable battery for charging the same.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a pictorial view of a connector charger according to a preferred embodiment of the invention.

FIG. 2 is a perspective view depicting the interior structure of a connector charger according to a preferred embodiment of the invention.

FIG. 3 is a perspective view depicting a connector charger and a rechargeable battery, whereas the battery is not yet connected to the connector charger.

FIG. 4 is a perspective view depicting a connector charger and a rechargeable battery, whereas the battery is connected to the connector charger.

FIG. 5 is a perspective view depicting a connector charger and a battery holder, whereas the battery holder is not yet connected to the connector charger.

FIG. 6 is a perspective view depicting a connector charger and a battery holder, whereas the battery holder is connected to the connector charger.

FIG. 7 is a pictorial view of a connector charger according to another preferred embodiment of the invention.

FIG. 8 is a circuit diagram of a charging circuit device according to a preferred embodiment of the invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

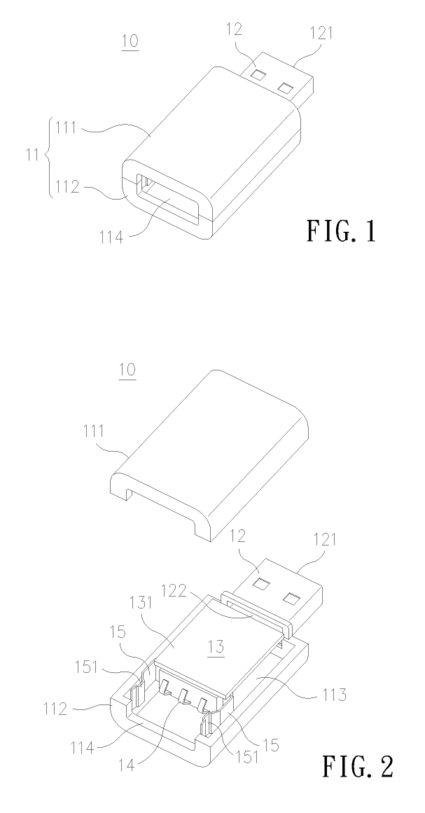

As seen in FIG. 1 to FIG. 4, the exterior of a connector charger 10 is a casing 11 composed of a top shell 111 and a bottom shell 112, whereas there is an accommodation space 113 formed inside the casing 11 while having a connection port 12 disposed at an end of the casing 11. The connection port 12 can include an universal serial bus (USB) port or a more advanced USB OTG (On-The-Go) port, but is not limited thereby. The outer end 121 of the connection port 12 is extruding outside the casing 11 that can be used for connecting electrically to an electronic device, such as a notebook computer, a desktop computer, an electricity storage device, etc., so that the power of the electronic device, usually of DC5V voltage, can be fed into the connector charger 10. In addition, the inner end 122 of the connection port 12, disposed inside the casing 11, is electrically connected to a charging circuit device 13.

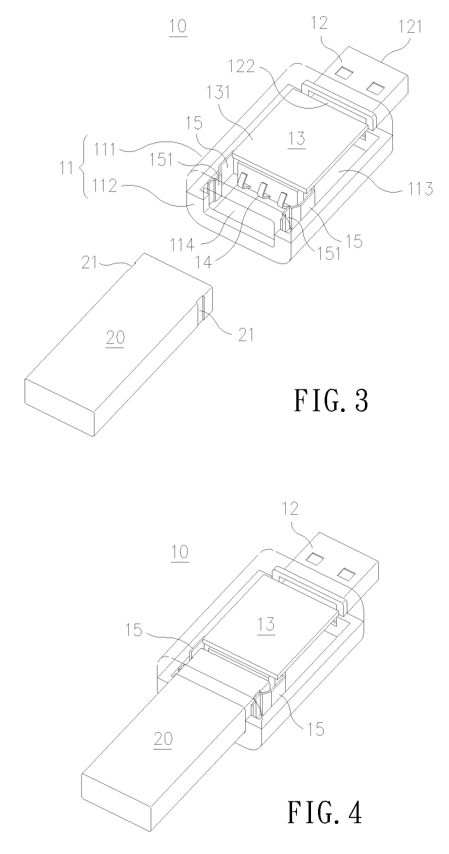

The charging circuit device 13 is disposed inside the accommodation space 113 of the casing 11, which is primarily a circuit board 131 with charging circuit formed thereon. Moreover, the circuit board 131 is electrically connected to a plurality of contacts 14. In FIGS. 1 to 4, each contact 14 is substantially a reed, however, it is not limited thereby and can be a spring or a structure combining a spring and a reed. As seen in FIG. 1, a socket 114 is formed on the casing at a position corresponding to the plural contact 14 for enabling a rechargeable battery 20 to be received/plugged into the casing 11 therefrom while enabling the rechargeable battery 20 to electrically connect to the plural contacts 14. In order to ensure the battery 20 to have exact contact with the plural contacts 14, two reeds 15 are relatively disposed at two opposite sides of the rechargeable battery 20 so as to be used as a positioning device for fixedly secured the rechargeable battery 20. Furthermore, each reed 15 is designed with an extruding portion 151 positioned at a position corresponding to an indentation 21 formed on the rechargeable battery 20, and thus the reeds 15 can securely hold on to the rechargeable battery 20 by fitting the extruding portions 151 into the indentations 21, as seen in FIG. 3. In FIG. 4, as the rechargeable battery 20 can be received/plugged in the casing 11 composed of the top shell 111 and the bottom shell 121, not only the rechargeable battery is protected by the casing 11, but also the aesthetic design of the whole structure is preferred.

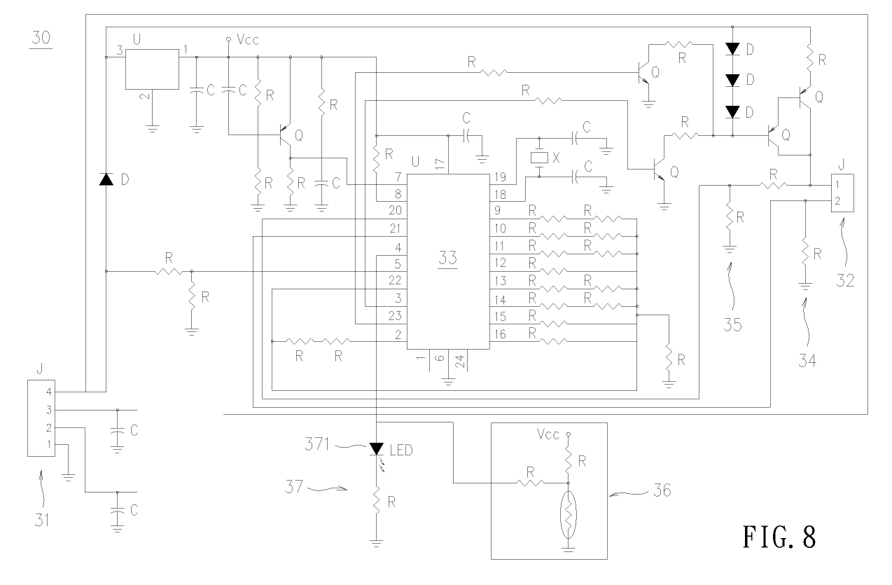

As the charging circuit device 13 is electrically connected to both the connection port 12 and the contacts 14 and when the connection port 12 is electrically connected to the external electronic device, the power of the external electronic device can be fed into the charging circuit device 13 where it is converted into electric current suitable for the rechargeable battery 20 and then the converted electric current is fed to the rechargeable battery 20 through the contacts 14 for charging the same. Please refer to FIG. 8, which is a circuit diagram of a charging circuit device according to a preferred embodiment of the invention. As seen in FIG. 8, the charging circuit 30 of the charging circuit device 13 is designed with a power input end 31 and a battery connection end 32, whereas the power input end 31 is substantially the aforesaid connection port 12 and the battery connection end 32 is the plural contacts 14. Moreover, the charging circuit 30 includes a micro-controller 33, a current detection circuit 34, a voltage detection circuit 35, a temperature detection circuit 36, and so on. In addition, the charging circuit 30 further comprises a charging indication circuit 37, for indicating statuses of electric quantity, charging state, power supply, and the likes. As for the layout of the charging indication circuit 37, it is not limited by the light emitting diode (LED) 371 shown in FIG. 4, and thus can be other audio/visual units of different audio and optical effects, such as a beeper, or an integrated device of a beeper and a LED. In a preferred embodiment, instead of being a constant-voltage charging circuit, the charging circuit 13 can be a switchable circuit, capable of switching between different voltages for enabling the same to charge batteries of different voltages, such as 1.2V Nickel Hydrogen battery, 1.2V nickel Cadmium battery, 2.0V Lead Acid battery, 3.6V Lithium Ion battery, 3.6V Secondary Lithium battery, and 3.6V˜3.8V Polymer Lithium battery, etc. As the charging circuit device is vastly applied and is known to those skilled in the art, it is not described further herein. In addition, it is noted that the rechargeable battery 20 can be a charging capacitor, or a combined structure of a charging capacitor and a rechargeable battery.

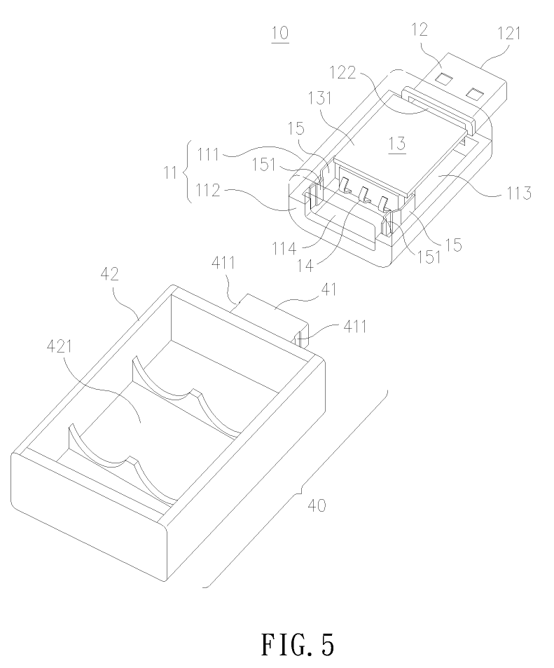

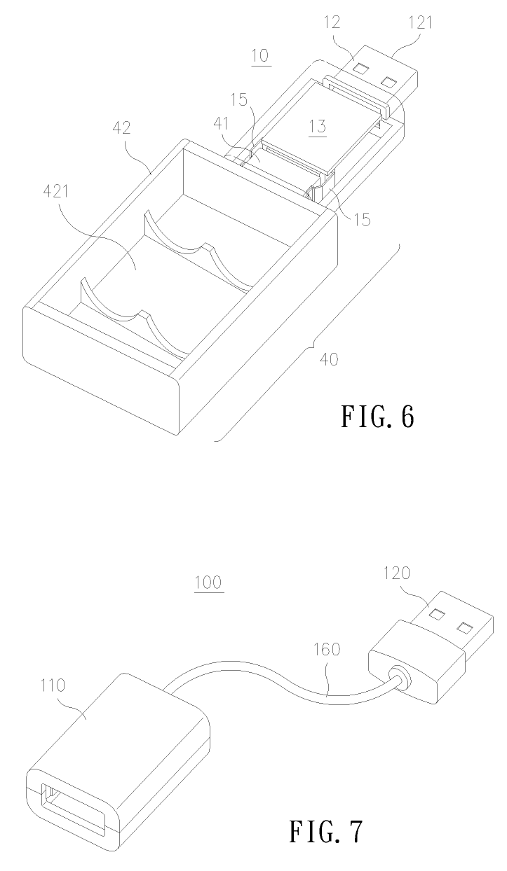

Please refer to FIG. 5 and FIG. 6, which is a perspective view depicting a connector charger with a matching battery holder according to a preferred embodiment of the invention. The battery holder 40 is composed of a holder head 41 and a case 42 connected to the holder head 41, in which is the holder head is structured the same as the potion of the rechargeable battery 20 of FIG. 3 that is used for plugging into the casing 11. Similarly, the holder head 41 is designed with an indentation 411 for fitting with the extruding portion 151 of each reed 15. As for the case 42, its inner space 421 is divided into a plurality of sections, each used for receiving a rechargeable battery. In addition, a conductive device is arranged between the case 42 and the holder head 41 and is electrically connected to those rechargeable batteries, by which the power of the external electronic device, connected to the connection port 12, can be fed to the rechargeable batteries of the inner space 421 for charging the same. As the charging principle and structure of the battery holder is the same as those conventional battery chargers, detail description is waived. The characteristic of the aforesaid embodiment is that: the so-structured connector charge is universal and is also low-cost and simple in structure, that is, if the shape of the plug-in head of the rechargeable battery or the battery holder is standardized for fitting with the reeds 15 of the casing 11, the connector charger is suitable to be applied by all kinds of electronic devices. As for the inner space 421 shown in FIG. 5 and FIG. 6, it can be divided into sections of various shapes and sized for matching those to batteries of different types and shapes. In FIG. 5 and FIG. 6, the inner space 421 is divided into two sections and is shaped for matching with two conventional cylinder-shaped batteries. However, it can be divided to match with other batteries of different shapes, such as the rectangular-shaped Lead Acid battery, in addition, it is not limited to be divided into two sections that there can be one section or more than one sections being formed in the inner space 421. Similarly, it is noted that the rechargeable battery 20 can be a charging capacitor, or a combined structure of a charging capacitor and a rechargeable battery.

Please refer to FIG. 7, which is a pictorial view of a connector charger according to another preferred embodiment of the invention. In this preferred embodiment, the connection port 120 of the connector charger 100 is structured to be disposed a distance away from the casing 110 and is electrically connected to the charging circuit device 13 and the contacts 14 by a connecting wire 160 of a specific length. When the connection port is connected to an external electronic device, the rechargeable battery plugged into the casing 110 can also be charged, which is similar in principle to the connector charger 10 of FIG. 1 and thus no detail description will be provided herein. As the connection port 120 is separated from the casing 110 and disposed a distance away, the connecting wire 160 is preferred to be received inside the casing 110 in a roll-up manner that can be pulled out of the casing and extends as long as it required for enabling the connection port 120 to connected to the external electronic device.

To sum up, the connector charge of the invention is able to access a power source through its connection port so as to use the power of the power source to charge various types of batteries by way of its specific interface and charging circuit device. Thus, it is practically feasible that can be adapted for computer peripheral devices and portable electronic devices.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A connector charger for charging rechargeable batteries, which is comprised of:
a casing, having an accommodation space formed therein;
a connection port, arranged at an end of its casing in an manner that it is channeling with the accommodation space and being adapted to electrically connect to an external electronic device;
a charging circuit device, arranged inside the accommodation space of the casing while electrically connecting to the connection port;
at least a contact, each disposed inside the casing while electrically connecting to the charging circuit device; and
at least a socket, each formed on the casing at a position corresponding to the at least one contact in a manner that each is channeling with the accommodation space;
wherein, as a rechargeable battery is connected electrically to the at least one contact, an electric circuit can be formed by the electrical-connection of the connection port, the at least one contact and the external electronic device so as to feed the power of the external electronic device to the rechargeable battery for charging the same.

2. The connector charger of claim 1, further comprising:
a positioning device used for fixedly secured the rechargeable battery while enabling the same to have exact contact with the at least one contact.

3. The connector charger of claim 2, wherein the positioning device is composed of reeds relatively disposed at two opposite sides of the rechargeable battery.

4. The connector charger of claim 3, wherein each reed is designed with an extruding portion positioned at a position corresponding to an indentation formed on the rechargeable battery, and thus the reeds can securely hold on to the rechargeable battery by fitting the extruding portion into the indentation.

5. The connector charger of claim 1, wherein the connection port can be structured to be disposed a distance away from the charging circuit device and is electrically connected to the charging circuit device by a connecting wire of a specific length.

6. The connector charger of claim 1, wherein the connection port further comprises an On-The-Go (OTG) port.

7. The connector charger of claim 1, wherein the charging circuit device further comprises a circuit board structured with charging related circuits of current detection, voltage detection, and the likes.

8. The connector charger of claim 1, wherein the charging circuit device further comprises a temperature detection circuit.

9. The connector charger of claim 1, wherein the charging circuit device is substantially a switchable circuit, capable of switching between different voltages for enabling the same to charge batteries of different voltages.

10. The connector charger of claim 9, wherein the charging circuit device further comprises a charging indication circuit, capable producing various audio and optical effects.

11. The connector charger of claim 1, further comprises a battery holder, including:
a holder head, used for connecting to the at least one contact;
a case, connected to the holder head and having an inner space formed therein for receiving at least a rechargeable battery;
a conductive device, disposed between the hold head and the inner space of the case so as to enable the at least one contact to be electrically connected to the at least one rechargeable battery for charging the same.

12. A charger, comprising:
a casing having a charging circuit at one end and a socket at the other end;
wherein, the connection port couples to an electronic device, and the casing has a charging circuit therein;
wherein, the socket at least has a contact coupled to the charging circuit, and a rechargeable battery plugs in the socket as to contact to the contact;
whereby, the electronic device charges the rechargeable battery via the connection port, charging circuit and the contacts.

13. The connector charger of claim 11, further comprises:
a battery holder, disposed between the rechargeable battery and the at least one contact, thereby, the power of the electronic device is fed to the rechargeable battery for charging the same through the connection port, the charging circuit, the at least one contact and the battery holder.

14. The connector charger of claim 12, wherein the rechargeable battery is a device selected from the group consisting of a charging capacitor and a combined structure of a charging capacitor and a rechargeable battery.

15. The connector charger of claim 12, wherein the connection port is connected to the casing by a connecting wire.
